(19) United States
(12) Patent Application Publication
(10) Pub. No.: US 2008/0228822 A1
(43) Pub. Date: Sep. 18, 2008

(54) SYSTEM AND METHOD FOR COUNTRY OF ORIGIN COMPLIANCE

(76) Inventors: Paul JARBOE, Houston, TX (US); Ted FRIEL, Tega Cay, SC (US); Noreen O'hara WELCH, Las Vegas, NV (US)

Correspondence Address: CHA & REITER, LLC, 210 ROUTE 4 EAST STE 103, PARAMUS, NJ, 07652, US

(21) Appl. No.: 12/041,120

(22) Filed: Mar. 3, 2008

Related U.S. Application Data
(60) Provisional application No. 60/904,365, filed on Mar. 2, 2007.

(51) Int. Cl. G06F 17/30

(52) U.S. Cl. 707/104.1; 707/E17.01

(57) ABSTRACT

A multi-faceted portal and method is provided for the pursuit, capture, maintenance and provisioning of Country of Origin data that confirms a government-contractor's compliance with at least one of the Buy Americas Act, the Trade Agreement Acts, and other trade acts as will be determined in the future. The current invention flexibly provides these capabilities and includes at least one of a hosted service and enterprise software licensing agreement that allows at least one of a manufacturer, importer, supplier, distributor or other government contractor, or auditor to manage the Country of Origin information included about products/services it supplies, by providing a self-authoring portal. The portal also trains users and certifies their training.

This application claims priority under 35 U.S.C. §119(c) from U.S. provisional application No. 60/904,365 filed Mar. 2, 2007, the contents of which are hereby incorporated by reference in its entirety.

### BACKGROUND OF THE INVENTION

1. Field of the Invention

The present invention relates to the capture, updating, and provisioning of information required to confirm that sources of supply being used for the quotation and delivery of products for government contracts comply with at least one of the Country of Origin requirements of the Buy Americas Act and the Trade Agreement Acts or reporting of any preferential or non-preferential compliance requirements as related to origin.

2. Description of the Related Art

The General Services Administration (GSA) Schedule is the largest and most widely-used method in the United States federal government for the purchase of commercial products and services. With $40 billion dollars in annual purchases made through the GSA schedule, government contactors are seeking ways to increase their sales by getting onto the GSA Schedule.

However, getting onboard the GSA Schedule is only the first step in the process of selling. In order to win contracts, government contractors need to be able to positively confirm that the sources of supply (suppliers) they are using for the quotation and ultimate delivery of products and services to a government agency comply with at least one of the Buy Americas Act and the Trade Agreement Acts.

In order to properly ensure compliance with these requirements, government contractors using international sources of supply are faced with increasing government scrutiny due to the heightened regulatory requirement of securing and maintaining information on the country of origin for a number of different purposes:

import restrictions;

preferential treatment for developing countries import discounts;

compliance with GSA contracts;

origin requirements for reporting any preferential requirements or other government requirements; and

other government regulations.

A government contractor must be able to prove to government audit agencies that they are doing more than making a “good faith effort” at securing valid information. The government contractor must have programs in place that actively pursue this information concerning its sources of supply, maintain accessible records of the information obtained, and is able to respond in an appropriate format when an audit is initiated by the contracting government agency. Lack of adequate systems can place the government contractor at risk of losing a bid for or loss of a lucrative government contract, expulsion from the GSA program resulting in loss of revenue. Worse yet, the audit could result in large penalties and fines as well as the public identification of the government contractor in government and other publications as being non-compliant and in violation of Federal Regulations.

Additionally, the ability to certify country of origin information provides the government contractor with a strategic differentiator over its competitors who may not be able to provide this information. It is also important from a marketing perspective to be able to offer different sources of supply to meet price point or customer affinity/loyalty needs.

Traditionally, government contractors have used outsourced services that provide manual data collection to obtain this country of origin information from their supply base or they have elected to forego the GSA schedule business opportunity altogether. The information obtained is often non-standard (i.e., un-normalized), lacks valid coding, and requires significant process/version control to manage multiple inputs being received for the creation and maintenance of country of origin information.

### SUMMARY OF THE INVENTION

Thus, a multi-faceted approach is needed for the pursuit, capture, maintenance and provisioning of country of origin data that confirms a government-contractor's compliance with at least one of the Buy Americas Act, the Trade Agreement Acts, preferential reporting requirements, any customs and trade reporting, and other trade acts as will be determined in the future. The present invention provides such a multi-faceted approach. The current invention flexibly provides these capabilities and combines: at least one of a hosted service and enterprise software licensing agreement that allows at least one of a manufacturer, importer, supplier, distributor or other government contractor, or auditor to manage the information included about items (products/services) it supplies, by providing a self-authoring portal. The portal according to the present invention typically includes:

training and certification of a manufacturer, importer, supplier, distributor or other government contractor personnel;

tools to facilitate the entry, quality control and updating of part, sub-assembly, and process data that determines the Country of Origin coding and labeling;

access to the rules and regulations for determining Country of Origin classifications;

access to services that include data cleansing, normalization and rationalization;

access to reports about, and graphical representations of, the parts, sub-assemblies, and transformation processes that comprise a product;

access to information about the people who provided the Country of Origin designations, and the information that supports their certifications;

data syndication to one or more users for one or more uses; as well as

links to consultative services thereto.

### BRIEF DESCRIPTION OF THE DRAWINGS

FIG. 1 illustrates how parts, sub-assemblies, and process components can be put together to form a product, and how the Country of Origin data coding can be associated with each product/service component

FIG. 2 illustrates a process flow diagram that shows how at least one of a manufacturer, importer, supplier, or distributor interfaces with the portal, receives training, gets certified, enters and cleans part/sub-assembly/process data, determines Country of Origin data and labeling, obtains Country of Origin supporting reports to accompany GSA proposals, and syndicates data output to other users and uses. FIG. 2 also illustrates how GSA or other audit personnel can utilize the portal to audit Country of Origin data.

FIG. 3 illustrates a product/service configuration screen that enables a user to configure a product/service based on components including parts, sub-assemblies, and process.

FIG. 4 illustrates an audit verification screen that enables a user to view the data and documents that support the Country of Origin designation for a product, or any of its components.

### DETAILED DESCRIPTION

The present invention is a method, apparatus and system for a self-authoring government-contractor/supplier/manufacturer/importer portal that supports Country of Origin data management.

In the discussions that follow, all examples are for expository purposes only and are not limiting in any sense. These examples are provided for clarification purposes only and are not indicative of any limits on the invention.

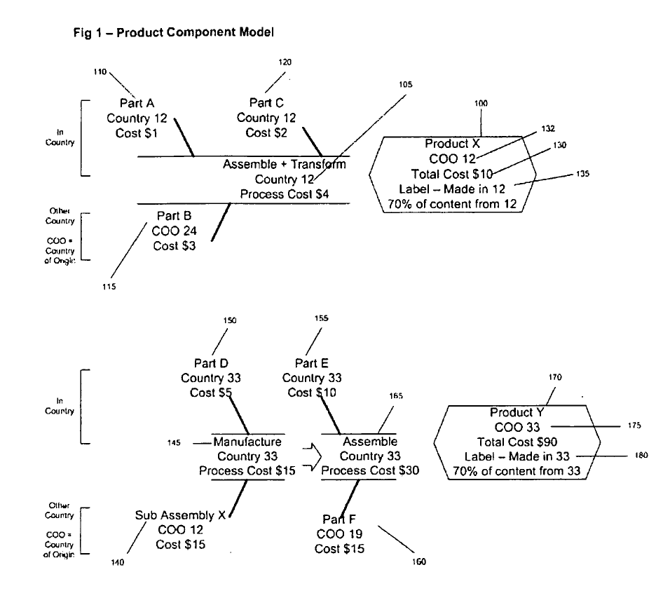

FIG. 1 outlines a basic component model that illustrates how parts, sub-assemblies, and processes may be combined to produce a product, and how Country of Origin data can be associated with each such product/service component.

In the upper half of the figure, Product/Service X 100 is assembled in country 12 105 from parts A, B and C. For the sake of clarity in this example, the parts listed above the process are from the country in which the process occurs, and the parts below the process come from outside the country where the process occurs.

Part A 110 comes from country 12, and costs $1. Part B 115 has a Country of Origin (COO) ID from country 24, and costs $3. Part C 120 comes from country 12 and costs $2. A manufacturer 105 in country 12 assembles and substantially transforms these parts in a process that results in the final product, labeled X 100. The total cost of the product/service (adding up the cost of the parts and the total cost of the processing, including processing costs, labor and overhead, is $10 130. Because the majority of the parts came from, and the manufacturing process occurred in, country 12 105, the Country of Origin is country 12 132. As a result, the label 135 that is put on the product/service can state “made in country 12”; the label can indicate 70% of the content comes from country 12. Here, the % is based on the dollar value of the items or process costs that are attributed to country 12.

In the lower half of FIG. 1, product/service X 100 is imported as a sub-assembly 140 into country 33 145. The manufacturer assembles part D 150, which costs $5, and the sub-assembly X 140, which costs $15, using a process 145 that costs $15. The manufacturer adds to this sub-assembly products E 155, costing $10, and F 160, costing $15, and assembles them 165, at a cost of $30, into the final product/service Y 170. Under the BAA and TAA rules, the manufacturer is able to designate the Country of Origin 175 for the product/service as country 33 since the location where the substantial transformation occurred was country 33, and the majority of the product/service costs came from the parts and sub-processes that originated in country 33. As a result, the manufacturer can label 180 the product/service as “made in country 33”, and can also add that “70% of the parts came from country 33”.

While FIG. 1 suggests an exemplary preferred configuration of components (parts, sub-assemblies, processes), a product/service can be made up of these and other components, and the diagram illustrating how these components are put together to create the product/service may take another form. For example, sub-assemblies may contain components that are themselves sub-assemblies, and the resulting diagram could resemble a tree-like structure with multiple levels of component breakouts.

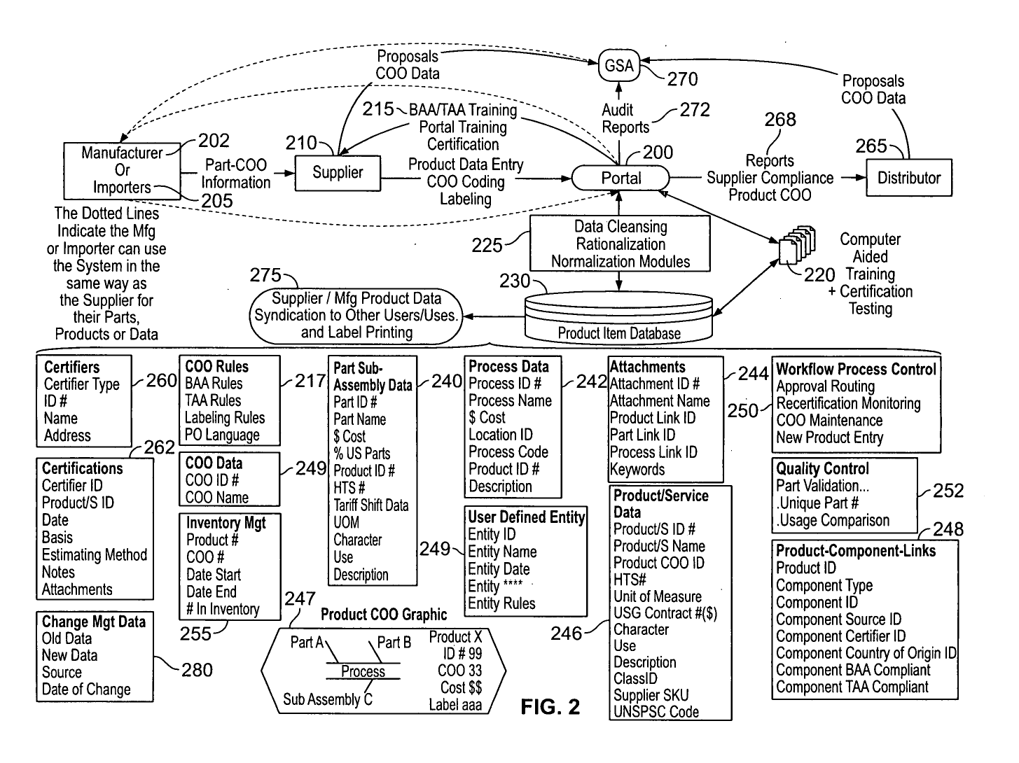

FIG. 2 illustrates an example of a basic model of how the self-authoring portal can be used by manufacturers, importers, suppliers, distributors, GSA contractors and auditors to manage Country of Origin data.

Now referring to FIG. 2, as outlined in items (I) to (VI) herein below, the portal 200 provides at least the following:

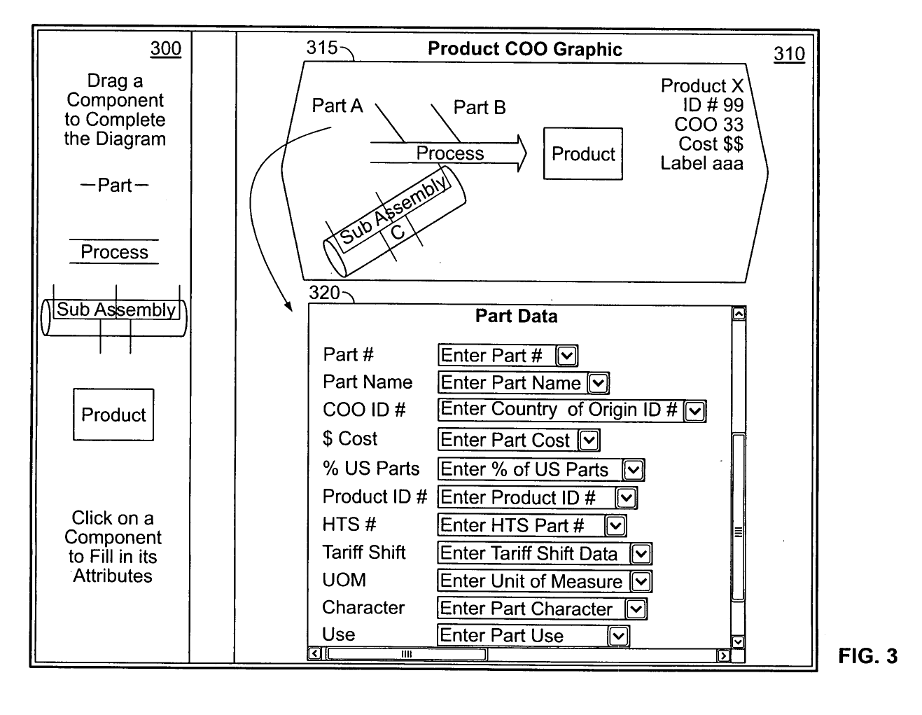

(I) Manufacturers 202, importers 205 and suppliers 210 with functions for:
Training 215 in BAA/TAA procedures, rules and requirements 217 by means of computer aided instruction 220. The training can also be supplied off line thru traditional instruction, or via a webex session;
Certification testing 220 that uses practical situations to test their knowledge and skill in applying the Country of Origin requirements and designating Country of Origin product/service codes and labels. The certification test can be administered off line and the data entered into the proper profile;
Data cleansing, rationalization and normalization modules 225 to cleanse and modify their data before storing it in a system product/service item database 230;
Storing in a product/service item database 230 a wide range of Country of Origin related data including:
   Data about parts and sub-assemblies 240;
   Data about processes such as assembling, fabrication, manufacturing 242.
   This data can be entered using a typical screen with data fields, or via a graphical interface. The graphical interface (FIG. 3) lets the user drag and drop part, sub-assembly and process icons onto the “page”, position them in a fishbone-like diagram to reflect the sequence in which the elements are worked on; and then enter data about each element in a pop-up type box that contains the relevant data field and drop down choices for elements in that object;
   Attachments and meta data about the attachments 244, including attachment ID #, attachment name, product/service link ID, part link ID, process link ID, and other descriptive information about the attachment that would facilitate efforts to search for it based on keywords; these attachments can provide supporting verification that the data entered is accurate.
   Data about the finished product/service or service 246 and an option to view a graphic representation of the components that went into creating the product/service 247
   Data linking product/service component type(s)—i.e., parts, sub-assemblies, processes—to the product/service 248; and identifying for a component the source, certifier, Country of Origin ID, and the extent to which the component is BAA or TAA compliant
   Data about Country of Origin countries and their identification numbers 249
Determining Country of Origin rules 217, and workflow process control tools 250, to ensure and document data quality 252 and secure the proper approvals for Country of Origin related data entry before committing the data to the database 230
Managing inventory data 255 (including product/service #, Country of Origin #, date the Country of Origin code started for that product, date the Country of Origin code ended for that product) with which suppliers and others can manage their inventory as it relates to Country of Origin requirements
Reporting certification data about the certifiers 260, which in some cases is the importer and the data or documents which represent their certifications 262 and the supporting basis for that certification that is presented in response to an audit request.

(II) Distributors 265 and other prospective GSA contractors (including suppliers, importers or manufacturers acting in that capacity) with functions for:
Training 215 in BAA/TAA procedures and requirements in the form of computer aided instruction 220. The training can also be supplied off line thru traditional instruction, or via a webex session.
Accessing all Country of Origin related data in the product/service item database 230 that is required for inclusion in a bid to GSA.
Reporting 268 on basic supplier and manufacturer Country of Origin data they can send to the GSA along with bids and proposals—to provide positive confirmation that they are in compliance with Country of Origin product/service data requirements. The reporting functionality can query and present any data in the product/service item database 230, labels for packaging, and data and formats required to respond to certification audit requests.
Providing, as part of the reporting functionality 268 suitable Purchase Order language to be included in all orders or as part of a master agreement or contract that incorporates a supplier's agreement to develop and maintain product/service information as required for Country of Origin Certification.
Monitoring supplier and manufacturer Country of Origin certifications 262, and requesting updates when past certifications are outdated. This includes the capacity to “turn off” a supplier who has not updated their outdated certification, and restrict their use of the portal.

(III) GSA contract officers 270 with functions for:
Accessing supplier and manufacturer Country of Origin detailed data in the product/service item database 230 to provide the required audit reports 272 to validate their Country of Origin data submissions.

(IV) Suppliers and manufacturers with functions for:
Syndicating 275 their product/service item data, and Country of Origin data, to other users and uses using various data formats including MS Excel, .csv, .txt, XML, and cXML.
Maintaining changes 280 to their Country of Origin related data each time a new or different part, sub-assembly, or process is included in a product; or a certifier is added or a certification is changed
Managing their inventory items 255 that are similar products, but have different Country of Origin codes, or labeling text, because one or more parts, sub-assemblies, or processes was modified in such a way that a different Country of Origin code or labeling text was required. This allows users to keep track of how many inventory items are available for each Country of Origin code that is assigned to the same product/service #.
Making contingency plans using the data in the product/service item database 230 for sourcing parts and sub-assembly components from different sources (i.e., manufacturers, importers, . . . ), if it is forecast that a particular country may be no longer able to provide acceptable components for political, economic or other reasons;
Printing labels 275 that contain the relevant product/service names and data, the proper Country of Origin data, and the proper labeling. The labels can be printed, they can contain bar codes, or the data can be stored in rid tags affixed to the product/service and packaging.

(V) All users with functions for:
Viewing a graphical representation 247 of the part/sub-assembly/process flow diagram for a given product/service that shows the sequence in which the components were put together, and reveals the data behind each element in pop-up type boxes when an element is selected, or a mouse-over event occurs, or the pop-up boxes are turned on to show up all at once.
Adding user defined entities 249 (i.e., data fields), defining the entities, and adding rules to establish how the entities interact with the other elements in the system; so that the users can customize the application to their unique, and perhaps dynamically changing needs.
Updating product/service related data elements to reflect date-sensitive changes, while retaining historical data, so that date-relevant reports can be run and date-sensitive decisions made. For example, when a product's components are changed, the new product/service configuration can be added to the product/service item database 230. The old configuration can be retained to account for products that are still in inventory, or to meet legislated requirements for data retention. This allows a user to identify products in inventory that comply with certain Country of Origin requirements and treat them differently from products with the same name that have a different Country of Origin designation—where the Country of Origin is time sensitive.

(VI) System administrators with functions for:
Updating and disseminating the BAA/TAA rules and requirements 217, and training materials and certification tests 220 if/when the goverment changes the requirements. For example, as Country of Origin rules change, the information in the product/service item database 230 and the training/certification materials need to change as well. The data being changed can be time stamped to reflect the start and end dates for which the information is relevant. The old material is retained to support decisions that were made in prior time periods to which the information applied.
Quality control verification processes for a part 252 by entering a common part # for all similar parts, and then running reports on the use of this similar part across sub-assemblies and products to ensure consistent and correct representation for the part.

FIG. 3 illustrates an example of a product/service configuration screen that allows a user to configure a product/service based on components thereof, including parts, sub-assemblies, and processes.

Now referring to FIG. 3, the frame on the left side 300 contains icons that represent product/service components. The user can drag a component to the right frame 310, and position it along with other components to represent the sequence by which the components are put together to create the product/service 315.

In an exemplary embodiment of the present invention, when a component in the right frame is clicked, a dialog box 320 is presented, in which the user enters data about the component.

In an alternative, non-graphic exemplary embodiment of the data entry process, each component is selected from a drop down list, data about each component is entered into the data fields representing that component type, and the components are re-sequenced to reflect the correct assembly process.

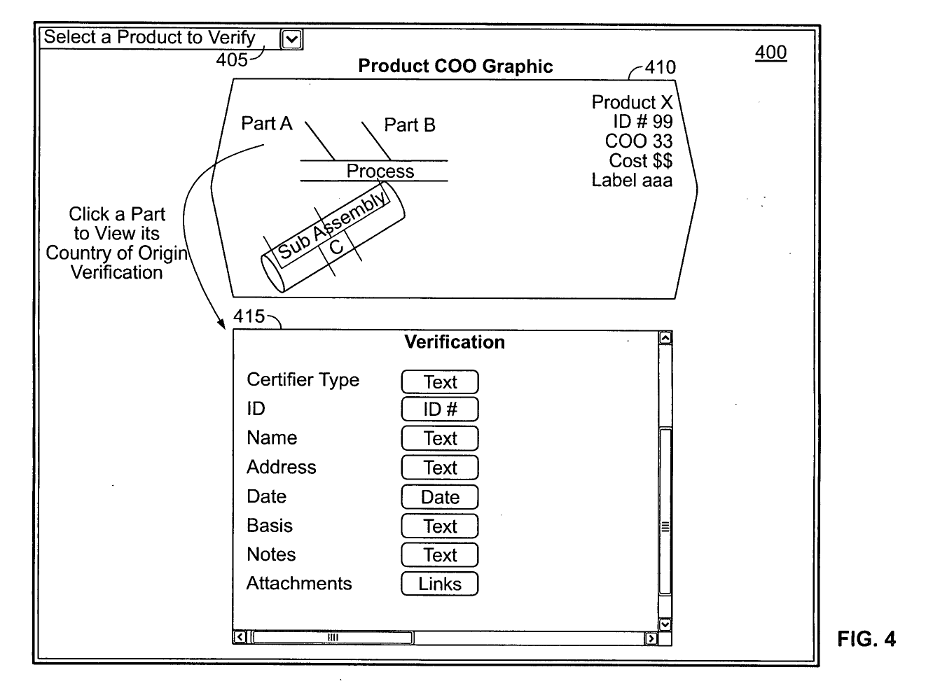

FIG. 4 illustrates an example of an audit verification screen that allows a user to view the data and documents that support the Country of Origin designation for a product, or any of its components.

An exemplary embodiment of the present invention provides an audit verification screen 400 that any user can select to review the basis for the Country of Origin designation for a product/service or its components. The user selects the product/service to verify 405. The product/service graphic is presented 410. The user can click on any product/service component to see the underlying certification data 415, which includes: the certifier type (i.e., importer, manufacturer); their id, name and address; the certification date, the basis for the certification, any notes that were entered about the certification, and links to any attachments (i.e., a completed customs form and signed statement from an importer) that support the certification data.

In summary, the present invention supports government-contractor/supplier/importer/manufacturer country of origin certification and is augmented by managed services to provide a complete turn-key solution that also includes government-contractor/supplier/importer/manufacturer enablement certification. Examples of the managed services include but are not in any way limited to:
Schema Management—which includes the creation, development, and management of a classification taxonomy for classifying and identifying items to be contained within an electronic catalog. The structure of the taxonomy is hierarchal in design with leaf level classes inheriting the attributes of the parent class. The leaf class also contains unique attributes specific to the characteristics of the class.
Content Cleansing—which includes cleaning data through the removal of invalid or incomplete information and expanding descriptions based upon available data contained within the load files.
Data Normalization—which includes the use of business rules to standardize content to prescribed formats and value such as capitalization, units of measure, removal of abbreviations, and standardized presentation.
Supplier Enablement—which includes training suppliers in the use of the application, providing support assistance for file loading, and communicating customer requirements for content values.
Hosting Services—which includes hosting the application within a secure data center and providing application and software support and maintenance.

Therefore, the present invention at least allows a government-contractor/supplier/importer/manufacturer to download all of its current catalog or web items to at least one of a hosted service and an enterprise system, among others, in the form of at least one of MS Excel spreadsheets and MS Access database files, XML, cXML, among others. Depending upon the type of system, e.g., whether it is a managed hosted service or an enterprise system, the host or the government-contractor/supplier/importer/manufacturer loads the files into a customized schema that is based on government-contractor/supplier/importer/manufacturer-specific profiles. The customized schema is included as a part of the services of the present invention. Since each customer can have a unique schema, and their own list of suppliers, they can also capture additional, unique data elements in the form of attributes in user defined fields.

The present invention supports quality control features that include a government-contractor's/supplier/importer/manufacturer's current table value validations for data entries including such entities as Unit of Measure, Country of Origin, and HTS. Additionally, government-contractor/supplier/importer/manufacturer name and address information is standardized (i.e., normalized) and presented in a consistent manner within the current invention, e.g., in outputs such as reports.

The present invention supports multiple country of origin options for each item supplied by a government contractor, validation points for trade agreement compliance, percentage of supply source, data for percent of origin content, (whether US or Non-US content), and the capacity to date stamp data changes to reflect the time frame during which the data is/was relevant. The present invention also provides User Defined Entities that enable users to capture information such as Lot Numbers or Serialization Numbers, or enter rules that reflect their unique situation, which may be needed to respond to their unique Country of Origin Certification requests.

The present invention enables suppliers, importers, distributors and government contactors to determine alternate sourcing strategies for product/service components that currently come from sources that they expect will not be able to provide adequate supplies in the future. By searching the product/service item database 230 for product/service substitutions that come from reliable sources, the supplier can switch sources when needed and still provide the agreed upon products that meet contractual requirements.

As illustrated in FIG. 2, government contractor, importer, manufacturer and supplier personnel are trained by employing the present invention to provide data elements/actions that include the following:
One or more country of origin sources for the item being supplied;
For each source, whether the item is compliant with at least one of BAA, TAA and other requirements;
For each item, a Harmonized Tariff Code for the item; and
For country of origin data and UOM data values, validation against ISO 9000 or other country code tables to ensure conformance to published standards.

Once the data elements have been entered and validated, the present invention performs actions including the following:
Uploading selected information contained within the Country of Origin modules to the government-contractor/supplier to support audit and compliance requirements for GSA contracts;
Keeping an audit trail of all government-contractor/supplier entries to track by date and time stamps which entity performed what change, and when does the change become effective and for how long;
Providing government-contractors/suppliers with positive confirmation that the items they supply to a government agency (customer) are acceptable under government contracts;
Providing On-line workflows to support government agency (customer) approvals by government-contractor/supplier category or merchandising managers thereof.

As data elements change, the system provides the user with the capacity to date-stamp data elements and supporting material to provide an audit trail of data changes, and a basis for differentiating and managing products whose Country of Origin designation has changed due to changes in its components or processes over time.

When trade agreement treaties change or are added, or Country of Origin rules or regulations change or are added, the underlying logic models for these objects will be modified to reflect the changes, and relevant services/agents will be utilized to update the elements in the system (i.e., database components, training information, certification processes) to reflect the “new” scenarios.

A system comprising the present invention is intended to be implemented within a pre-agreed upon time-frame from date of contract, as a hosted managed service. Government agencies (customers) can also license the present invention as a component of an in-house enterprise system wherein the time-frame for implementation depends on other factors, such as the completion of the in-house enterprise system and its interfaces to the present invention.

As noted above in the discussion of the prior art, traditionally, government contractors have either relied upon their ERP solution or outside services to try to meet the Country of Origin Certification requirements. Currently, most major ERP solutions do not provide the ability for a single item to be linked to multiple sources of supply. These ERP solutions have limited their users to a single item with a single country of origin designation requiring government contractors to create multiple part numbers for the same item in order to provide multiple sources of supply. This process is very inefficient and error prone. Further, it does not allow the actual supplier, who has the greatest information about the item, to participate actively in a portal environment to assist the government contractor in keeping the information accurate and current.

Outsourced services have often used the approach of “throwing” lots of bodies at the problem to try and manually capture the information. This leads to inconsistencies in values, lack of accuracy, confusion over file versions and version control, and lack of reportability to customs or other government agencies who may need this information in order to determine program compliance.

The Managed Service structure of an exemplary embodiment of the present invention provides a total, turn-key solution that can be provided to a government-contractor on a subscription basis. The present invention provides full security, disaster recovery, infrastructure and application administration while the government-contractor maintains ownership and full access to its data. The managed service embodiment provides secure web access with no infrastructure investment required and little or no IT involvement required.

However, the present invention further includes an embodiment that is capable of being licensed to the government contractor and can be accessed by suppliers thereto, if it proves to be more cost effective or otherwise advantageous.

Under the managed service exemplary embodiment:
Government contractor suppliers are trained and certified;
Government contractor product/service data is populated into the embodiment by the managed service provider;
Government contractor suppliers are assisted in performing data entry;
Accuracy of data is validated;
Service provider monitors and manages supplier compliance; and
Exceptions are managed with government contractor for 100% compliance.

Referring again to FIG. 2, an embodiment of the present invention comprises the components:
Supplier Table Import—All supplier names and addresses are exported from the Master Record repository and loaded into the supplier portal via, for example, a MS Excel spreadsheet or through integration with a host purchasing system. All formatting and punctuation are based upon the format of the host purchasing system. Supplier Account IDs are also be part of this load table.
Supplier Item Import—All known items purchased from a supplier (products) are exported from the supplier's host purchasing system and loaded into the supplier portal of either a Managed Hosted Service or a supplier Enterprise System (that include country of origin functionality) via a predetermined formatted input such as an MS Excel spreadsheet, MS Access database or XML document for the initial load only (but not limited thereto). Thereafter, suppliers are responsible for maintaining the items within the supplier portal including the Customer Product/Service ID, all sources, country of origin, HTS values, UOM, and positive confirmation of the products' qualifications for the stated programs (e.g., TAA or BAA compliance).
Supplier Training—Suppliers are trained using modules of the supplier portal as training tools and by Host/Enterprise Supplier Enablers regarding how to:

(1) Logon to/register with the supplier portal

(2)Use a template/schematic provided by the supplier portal that is adaptable to government agency and country of origin requirements to provide information for various functions
Load new items
Maintain existing items
Update item source information
Maintain product/service compliance information, and
Submit the information for approval.
Purchase Order Language—suitable Purchase Order language is included in all orders or as part of a master agreement or contract that incorporates a supplier's agreement to develop and maintain product/service information as required for Country of Origin Certification.

It should be noted in the discussion of embodiments that at least two broad classes of country of origin systems are a Managed Host Service that has an automated supplier portal to allow suppliers to provide country of origin data and a Host Enterprise System that includes a licensed automated subsystem having an automated supplier portal to allow suppliers of government contractors to provide country of origin data concerning the products supplied. Both classes include all the above-described automated functions and features and further include audit trails to capture positive confirmation of supplier compliance with country of origin regulations that comprise, but are not limited to BAA and TAAs. Further, a particular government contractor can authorize access to an auditing government agency to the country of origin data provided by its suppliers by setting up a user account for that agency. In addition, since country of origin data is perishable, every embodiment will incorporate expiration dates for the various supplier data and the supplier is limited to use prior to such expiration dates of the features associated with the various supplier data. Once such expiration dates have passed, the supplier must again positively confirm its country of origin data.

It should also be noted that certification of suppliers as sources of Country of Origin data is included in the present invention. Automated training modules act as “wizards” for educating suppliers (users) about the requirements and use of the present application. Such training modules are especially noteworthy in that such automated training modules encapsulate the current state of trade agreements and associated regulations with provision for keeping track of those suppliers whose training and certification as sources of Country of Origin data must be updated to maintain the currency of supplier training with such agreements and regulations.

Terms, definitions and requirements associated with Country of Origin determinations that are used in the training and certification programs, and the design of database fields, are drawn from sources publicly available. It should be understood that the following references are provided merely as guide, and the specific terms and regulations are subject to change. The present invention is designed broadly so as to function not only within the current framework of definitions and requirements, but as a person of skill in the art will appreciate, it also is within the spirit and scope of the present invention to function with any modifications made to the Country of Origin specifications. Such terms and definition, etc. include:

US Government information programs:
Definitions of terms relevant to the Country of Origin determination process from http://usinfo.state.gov/products/pubs/trade/glosssz.htm#t, which provides definitions of terms relevant to the Country of Origin determination process.
Federal Trade Commission enforcement policies from http://www.lawpublish.com/ftc-madeusa.html, which provides the text of the FTC's enforcement policy statement with respect to the use of “Made in USA” and other U.S. origin claims in labeling;
US Treaty Laws from http://www customs.ustreas.gov/nafta/naftafrm.htm, which provides details about the NAFTA trade agreement, and the customs provisions related to Country of Origin.
International Trade Commission Tariff Schedule from http://www.usitc.gov/tata/index.htm, which provides detailed information about the Harmonized Tariff Schedule and coding System and their use in Country of Origin determination and data management;
US Codes—Public Contracts, and Custom Duties from http://uscode.house.gov/uscode-cgi/fastweb.exe?getdoc+uscview+t41t42+21+0++%28%29%20%20AND, which provides details into the Country of Origin requirements for items purchased by the US government that are acquired for public use.
Provides details into the Country of Origin requirements for items purchased by the US government from countries that are eligible under the African Growth and Opportunity Act from http://uscode.house.gov/uscode-cgi/fastweb.exe?getdoc+uscview+t17t20+2531+0++%28%29%20%20AN D%20%28%2819%29%20ADJ%20USC%29%3ACITE%20AND%20%2 8USC%20w%2F10%20%282512%29%29%3ACITE%20%20%20%20% 20%20%20%20%20

http://www.access.gpo.gov/nara/cfr/waisidx₁₃06/19cfr102_{—}06.html

Federal Regulations—Country of Origin references

http://www.gpoaccess.gov/cfr/index.html

Provides details into the Country of Origin requirements imposed by the bureau of Customs and Border Protection, and the Departments of Homeland Security and Treasury

http://frwebgate.access.gpo.gov/cgi-bin/multidb.cgi?WAISdbName=cfr+Code+of+Federal+Regulations+%28current+data%2 9&WAISqueryRule=%28%24WAISqueryString%29&WAISqueryString=%22country+o f+origin%22&WAIStemplate=multidb_results.html&Submit.=Submit&WrapperTemplat e=cfr_wrapper2.html&WAISmaxHits=120

The results of a search for Country of Origin related material at GPO's National Archive and Records database.

Buy America Act Guidelines

http ://www.sandia.gov/policy/34g.pdf

Provides detailed information about Country of Origin requirements under the Buy America Act.

http://www.acquisition.gov/far/current/html/Subpart%2025_{—}1.html

Provides additional detailed information about Country of Origin requirements under the Buy America Act.

US Customs and Border Protection References:

http://cbp.gov/

This is the home page for the US Customs and Border Protection web site.

http://search.cbp.gov/query.html

Provides detailed information on the Country of Origin requirements and rulings from this bureau.

Federal Acquisition Regulations

http://www.arnet.gov/far/

Provides the text of the Federal Acquisition Regulations, which includes Country of Origin requirements—for example, Part 25 which addresses foreign acquisitions.

US Trade Representation References

http://www ustr.gov/

This is the office of the US Trade Representative web site.

http ://search.crownpeak.com/cpt_search/result_?account=1003&q=country+of+origin

Provides a list of the USTR documents related to Country of Origin requirements and rulings

US Trade Agreements information can be found at http://www.arnet.gov/far/current/html/52_{—}223_{—}226.html#wp1169151, which provides detailed information about US trade agreements that effect Country of Origin determinations; and

http://www.access.gpo.gov/uscode/title19/chapter13_.html provides detailed information about Custom Duties and the Trade Agreement Act of 1979 that effect Country of Origin determinations.

Thus, a first exemplary embodiment of present invention is directed to a self-authoring portal that can be used by the full range of people performing capture, approval, quality control, storage, maintenance, syndication and reporting of Country of Origin determinations, including: manufacturers, importers, suppliers, distributors, and government contactors, and government audit personnel. Self authoring refers to the ability of a specific class of users being able to import their product/service data and perform their user-class-specific capture, approval, quality control, storage, maintenance, syndication and reporting functions by having the self authoring components recognize the user class and invoke the appropriate modules or invoke self authoring modules to create and store the user class specific characteristics for future use in performing these functions.

Capture includes importing, or entering, attribute data related to parts, sub-assemblies, and processes that make up a product; and establishing a graphic image that incorporates the sequence and relationships between the parts, sub-assemblies, and process that make up the product.

Approval includes routing selected information via a pre-defined workflow process to get go/no-go ratings from selected approvers.

Quality control includes passing the created information through modules that normalize and rationalize the data to meet usability requirements.

Storage includes maintaining the corrected, approved data in a database for the duration of its useful life, and archiving the data as required to satisfy government regulations.

Maintenance includes tracking data usability timeframes and modifying the availability and use of a data item whose usability date has expired; and initiating data update workflow processes to restore a suspended data item to full access status.

Syndication includes exporting selected items in the database in a variety of required formats—i.e., EXCEL, .csv, .txt, XML, cXML, etc—to external systems or users for a variety of uses.

Reporting includes the extraction of selected information from any element in the database to provide the right information to the right people at the right time in the right format to support an actionable decision.

A user performs multiple roles—i.e., a supplier can also be an importer.

The self authoring portal supports a computer aided instruction of Country of Origin requirements and procedures for all users, wherein
the computer aided instruction being customizable to the needs of each target audience said audience selected from the group consisting of importer, manufacturer, supplier, distributor, government contractor, and auditor; and
the computer aided instruction being updatable as needed to comply with changes to Country of Origin requirements and procedures.
   The self authoring portal, comprises a computer based certification platform for Country of Origin including requirements and procedures for products and services of at least one designated user; and recertification of products whose prior certification has expired.

The self authoring portal, comprises data modules to cleanse, rationalize and normalize data before storing it in a database, wherein:
cleansing includes defining characters that should be removed from incoming data and capturing said defined characters for re-used in subsequent cleansing.
rationalizing includes making unclean data more structured and consistent, such that processing said unclean data is quicker, easier and more effective; and further comprises modules for:
   conversion of hard copy data to an electronic format;
   movement of data from improper fields to improve data organization;
   correction of misspelling to improve data consistency;
   modification of data to meet standards—such as required abbreviations;
   removal of duplicate data; and
   addition of tags to data to facilitate its proper classification
   normalizing includes making the same information consistent across all data items—i.e., a manufacturer's name is spelled the same way wherever it appears.

The self authoring portal, further comprises:
a module that enables users to define a label for a product, and prints the label using text and barcodes to be affixed to the product;
a module that outputs the label information as an RFid tag that to be affixed to the product; and enables users to get a full range of report output from all data stored in a database, comprising reports selected from the group consisting of:
product breakdown reports—i.e., information about their components, including a listing of the Country of Origin data elements associated with each component, any documentation supporting the data elements, and a graphic image of the parts, sub-assemblies, and processes that make up the product,
user information—where users can be manufacturers, importers, suppliers, distributors, or government contractors—including their profile data, their certification data, and their associated products,
workflow process control data that identifies the workflow processes, the people and tasks involved, and the status of the process,
inventory data that enables a user to manage their inventory,
Country of Origin related rules and regulations, and
change management information that keeps track of what key data items were changed, when, and by whom, and who approved of the change.

The self authoring portal also comprises modules that allow an auditor to review and report on the data and documents that support the basis for a Country of Origin certification of a product; and view a data profile of the persons that performed the certification of the product.

The present invention also provides a method for manufacturers, importers, suppliers, distributors, government contractors and contract auditors to perform at least one of capture, approve, quality control, store, maintain, export, syndicate or use data relevant to a product's Country of Origin determination for purposes such as complying with government contracting requirements, comprising the steps of:

a manufacturer creating a part, a sub-assembly or a product;

an importer moving an item through customs;

a supplier acquiring products, parts or sub-assemblies from others, and transforming them in one of a minor or major way into products then made available to others;

a distributor acquiring products from suppliers, or others, and making them available to customers.

In the exemplary method according to the present invention, government contractors may be manufacturers, importers, suppliers, distributors or others who submit bids comprising products in response to government contract opportunities and capturing involves importing, or entering, attribute data related to parts, sub-assemblies, and processes that make up a product; and establishing a graphic image that incorporates the sequence and relationships between the parts, sub-assemblies, and process that make up the product.

In the exemplary method according to the present invention, the approval includes the step of routing selected information via a pre-defined workflow process to get go/no-go ratings from selected approvers.

In the exemplary method according to the present invention, quality control further includes the step of passing the created information thru modules that normalize and rationalize the data to meet usability requirements.

In the exemplary method according to the present invention, storage further includes the steps of maintaining the corrected, approved data in a database for the duration of its useful life, and archiving the data as required to meet regulations.

In this exemplary method according to the present invention, maintenance further includes the steps of tracking data usability timeframes and modifying the availability; using a data item whose usability date has expired; and initiating data update workflow processes to restore a suspended data item to full access status.

In this exemplary method according to the present invention, syndication further includes the step of exporting selected items in the database in a variety of required formats—i.e., EXCEL, .csv, .txt, XML, cXML, etc—to at least one of an external system and a users for a plurality of uses thereof.

In this exemplary method according to the present invention, use further includes obtaining reports that represent the extraction of selected information from any element in a database to provide the timely, formatted information for support of an actionable decision.

In the exemplary method according to the present invention, Country of Origin determination includes the steps of identifying the product's country of origin based on the rules and regulations relevant to the product, parts, sub-assemblies, and processes, and the trade agreements the USA has with the country(s) involved in the lifecycle of the product.

In the exemplary method according to the present invention, government contracting requirements are determined by the regulations specified by the BAA, TAA, FTC, GSA, and other sources that place restrictions on government contractors wishing to do business with the government.

A first alternative exemplary embodiment of the present invention provides a system, which may comprise:

a self authoring portal that includes

a. data quality control modules to control data quality,

b. data approval processes to approve data for storage in a database,

c. network communication elements for remote user access to modules and processes and data in the data base,

d. computer-aided training and certification modules that employ the data quality control and approval processes to train local user and the network communication elements to train remote users,

e. syndication modules that syndicate data stored in said data base using said network communication elements, and

f. reporting modules that enables a wide range of users, including auditors, to manage data stored in said database using said data modules and processes and said network communication elements, said stored data being relevant to Country of Origin designations required for government contracts.

In the first alternative exemplary embodiment, the self authoring portal is a browser-based interface to the portal that enables a user to perform data entry to enter product data required to support Country of Origin data processing by said data module and processes using said network communication elements to store a result of said data processing in said database.

The data entry of the first alternative exemplary embodiment is one of keyed into a displayed form and imported electronically from a source local to the portal or a remote source using said network communication elements.

The product data of the first alternative exemplary embodiment includes product components selected from the group consisting of parts, sub assemblies, processes, and meta data describing the components comprising attributes that define the component, such that each component includes at least one of a similar and unique data element attribute.

The product components of the first alternative exemplary embodiment are organized into a graphic representation of the processes by which the components were assembled to create the final product.

The portal of the first alternative exemplary embodiment further includes a plurality of ways to enter product data including at least one screen form on a component by component basis, and a graphic “fishbone-like” representation of how the components were put together to create the product:

a popup form from which the user selects a component of the graphic representation and fills out attribute data about the component therein; and

at least one user-defined field for each product and component that the user designates for a particular purpose, and defines the nature of the data that populates the user-defined field.

In the first alternative exemplary embodiment, data quality control modules include the ability for the user to clean, normalize and rationalize product data before storing it in a database.

In the first alternative exemplary embodiment, data approval processes include routing selected information via a pre-defined workflow process to obtain ratings from selected approvers.

In the first alternative exemplary embodiment, the database includes at least one relation tables having at least one row for storing data.

In the first alternative embodiment, the network communication elements include wired and wireless components that enable remote and local users to access the portal and communicate with the database using the data modules and processes.

In the first alternative exemplary embodiment, the computer aided training modules include instructional modules designed to present rules and requirements related to Country of Origin data management, and test an ability of a user to make proper discriminations and take appropriate actions to demonstrate that the user can act upon the rules and requirements.

In the first alternative exemplary embodiment, the certification modules include a test to verify that a user understands and can act upon the rules and requirements of Country of Origin data management.

In the first alternative exemplary embodiment, the syndication modules include the an export of selected data from the database in a format that is suitable for conveyance to and input into another system or use, the format selected from the group consisting of EXCEL, .csv, .txt, XML, and cXML.

In the first alternative exemplary embodiment, the reporting modules include a capability for a user to access the database to support an actionable decision.

In the first alternative exemplary embodiment, the range of users includes user types each being at least one type selected from the group consisting of manufacturers, importers, suppliers, distributors, government contractors, and compliance auditors.

In the first alternative exemplary embodiment, the Country of Origin designations include a Country of Origin ID, a country name and satisfy at least one requirement for Country of Origin designations established by the BAA, TAA and other rules, regulations and agreements that apply.

In the first alternative exemplary embodiment, the compliance auditors can access the system via the portal for one or more products, and review: the Country of Origin designations; the name, ID and profile of the person(s) certifying the designations

While exemplary embodiments and examples have been provided in the foregoing discussion of the present invention, these exemplary embodiments and other examples herein pertaining to the system and method for country of origin compliance are not limiting in any sense and are included for expository purposes only to clarify and identify some of the characteristics of the present invention.

We claim:

1. A Country of Origin portal for user-specific and product/service-specific Country of Origin functionality, comprising:
a database for storage of a plurality of product/service Country of Origin data and a plurality of product/service Country of Origin executable functional data manipulation modules, and a plurality of portal user personality data and a plurality of portal user personality executable functional definition modules,
wherein, each of said plurality of Country of Origin data has a corresponding status; and
at least one computer operatively connected to the database for access thereto and instantiation of at least one user personality by executing at least one of said plurality of personality functional definition modules using at least one of said user personality data, wherein, said instantiated personality is persistently stored in said database for use by a corresponding class of users to access said plurality of product/service Country of Origin executable functional modules to define, store, manipulate and retrieve at least one of said plurality of product/service Country of Origin data as normally accomplished by the corresponding class of users,
wherein, each said product/service comprises a tree structure of at least one component product, each said at least one component product/service being capable of further definition as comprising at least one component product/service thereof in said database until each said at least one component product/service only comprises at least one product/service produced by a single Country of Origin.

2. The portal of claim 1, wherein:
the product/service Country of Origin executable functional data manipulation modules are selected from the group consisting of capture, approval, quality control, storage, maintenance, syndication and report generation of Country of Origin data; and
the user personality is selected from the group consisting of product/service manufacturers, product/service importers, product/service suppliers, product/service distributors, government contactors, and government audit personnel.

3. The portal of claim 2, wherein capture includes:
entry of single Country of Origin data for each said at least one component product/service including component product/service interrelationships and corresponding approval workflow processes for user personalities; and
entry of a graphical image data that incorporates the sequence of and relationships between component products and the corresponding approval workflow processes of user personalities.

4. The portal of claim 2, wherein approval includes routing selected data using a pre-defined approval workflow process to obtain go/no-go ratings from selected user personalities.

5. The portal of claim 2, wherein quality control includes processing the entered data with executable functional data manipulation modules that normalize and rationalize the data to meet at least one pre-defined usability requirement that includes a usability timeframe.

6. The portal of claim 2, wherein storage in the database includes storage of a corrected, approved data in the database for a duration of a pre-defined “useful life” thereof, and archival of the corrected, approved data as required to comply with at least one pre-determined government regulation for retention of Country of Origin corrected, approved data.

7. The portal of claim 1, wherein storage in the database includes storage of a corrected, approved data in the database for a duration of the pre-defined “useful life” thereof, and archival of the corrected, approved data as required to comply with at least one pre-determined government regulation for retention of Country of Origin corrected, approved data.

8. The portal of claim 3, wherein storage in the database includes storage of a corrected, approved data in the database having a pre-defined “full-access” status for a duration of a pre-defined “useful life” thereof, and storage of the corrected, approved data having a pre-defined “archived” status as required to comply with at least one pre-determined government regulation for retention of Country of Origin corrected, approved data.

9. The portal of claim 2, wherein maintenance includes:
tracking a pre-defined “useful life” of data stored in the database and modifying the pre-defined “useful life” status to a pre-defined “expired” status when a usability date of the “useful life” of the stored data has expired; and
initiating a pre-defined data update workflow process to restore stored data having an “expired” status to a pre-defined “full access” status.

10. The portal of claim 6, wherein maintenance includes:
tracking a pre-defined “useful life” of data stored in the database and modifying the pre-defined “useful life” status to a pre-defined “expired” status when a usability date of the “useful life” of the stored data has expired; and
initiating a pre-defined data update workflow process to restore stored data having an “expired” status to a pre-defined “full access” status.

11. The portal of claim 7, wherein maintenance includes:
tracking the pre-defined “useful life” of data stored in the database and modifying the pre-defined “useful life” status to a pre-defined “expired” status when a usability date of the “useful life” of the stored data has expired; and
initiating a pre-defined data update workflow process to restore stored data having an “expired” status to a pre-defined “full access” status.

12. The portal of claim 8, wherein maintenance includes:
tracking the pre-defined “useful life” of data stored in the database and modifying the pre-defined “useful life” status to a pre-defined “expired” status when a usability date of the “useful life” of the stored data has expired; and
initiating a pre-defined data update workflow process to restore stored data having an “expired” status to a pre-defined “full access” status.

13. The portal of claim 2, wherein syndication includes exporting selected data stored in the database in a plurality of required formats selected from the group consisting of EXCEL, .csv, .txt, XML, and cXML to at least one external system.

14. The portal of claim 2, wherein report generation includes selection, according to user-specified criteria, data stored in the database to provide the selected data in at least one pre-determined format.

15. The portal of claim 2, wherein a user can specify and assume multiple user personalities when using the portal.

16. The portal of claim 1, wherein the plurality of Country of Origin executable functional data manipulations includes at least one computer-aided-instruction module that teaches Country of Origin requirements and procedures to all user personalities, wherein
the at least one computer-aided-instruction module is customizable to a user personality; and
the at least one computer-aided-instruction module is updatable, as needed, to comply with changes to Country of Origin requirements and procedures.

17. The portal of claim 1, further comprising at least one Country of Origin functional data manipulation module that certifies Country of Origin data a product/service stored in the database for a certification duration according to pre-determined requirements and procedures for products/services of at least one designated user and that recertifies said Country of Origin data of said products/services whenever said certification duration expires.

18. The portal of claim 1, further comprising at least one Country of Origin functional data manipulation module for each of cleanse, rationalize and normalize product/service and service data prior to storage thereof in the database.

19. The portal of claim 18, wherein cleanse further includes definition of characters to be removed from entered data and capture of said defined characters for re-use in a subsequent cleanse of entered data.

20. The portal of claim 18, wherein rationalize further includes executable functional data manipulation modules for:
conversion of hard copy data to an electronic format,
movement of data from improper fields to improve data organization,
correction of misspelling to improve data consistency,
modification of data to meet standards,
removal of duplicate data, and
addition of tags to data to facilitate its proper classification,
wherein application of each said module results in rationalized data that is more structured and consistent, such that processing said rationalized data is quicker, easier and more efficient.

21. The portal of claim 18, wherein normalize further includes representing a same information in a consistent manner across all stored data.

22. The portal of claim 1, further comprising:
a product/service Country of Origin executable functional data manipulation module to define label information for a product/service that includes Country of Origin code, and print the label information using text and barcodes to be affixed to the product/service; and
a product/service Country of Origin executable functional data manipulation module that outputs the label information as an RFID tag to be affixed to the product/service.

23. The portal of claim 1, further comprising product/service Country of Origin executable functional data manipulation modules that enable users to specify selection criteria and generate report output from all data stored in the database, said report output selected from the group consisting of:
product/service breakdown reports including information about product/service components, including a listing of Country of Origin data associated with each component, any documentation supporting the data elements, and a graphic image of the parts, sub-assemblies, and processes that comprise the product/service,
user information wherein user is selected from the group consisting of manufacturer, importer, supplier, distributor, and government contractor and includes user profile data, user certification data, and user associated products/services,
workflow process control data that identifies at least one workflow process, users and tasks involved in each said identified workflow process, and a status of each identified workflow process,
inventory data to allow a user to manage an inventory,
Country of Origin related rules and regulations, and
change management information to track when, where, by whom, and approved by whom whenever stored data are changed.

24. The portal of claim 1, further comprising executable data manipulation modules that allow an auditor to review and report on any stored data that supports a basis for a Country of Origin certification of a product/service; and view a user profile of any user that performed the certification of the product/service.

25. A method for a Country of Origin certification portal, comprising the steps of:
providing a database for storage of a plurality of product/service data that includes Country of Origin data;
selecting by a user a personality from the group consisting of manufacturer, importer, supplier, distributor, government contractor and contract auditor to perform at least one of function selected from the group consisting of capture, approve, quality control, store, maintain, export, syndicate the product/service Country of Origin data stored in the database.

26. The method of claim 25, wherein the capture function comprises the steps of:
capturing product/service data in a database by performing one of importing and entering parts, sub-assemblies, and processes of a product/service;
establishing a graphic image that includes a sequence of relationships between the parts, sub-assemblies, and processes of the captured product/service data;
determining Country of Origin for the captured product/service data by performing the steps of identifying the product's country of origin based on a set of pre-specified rules and regulations relevant to the product/service and component parts, sub-assemblies, and processes thereof,
certifying a determined Country of Origin using regulations specified by at least the BAA and TAA trade agreements and the FTC and GSA administration thereof, that the USA has with the determined Country of Origin of a product/service and storing in the database said certification as certification data associated with the product/service.

27. The method of claim 26, wherein:
the approval function comprises the steps of approving the captured product/service data by performing routing of said captured product/service data and said established graphic image via a pre-defined workflow process, and obtaining at least one go/no-go rating from at least one pre-selected approver;
the quality control function comprises the steps of normalizing and rationalizing the approved product/service data to meet pre-determined usability requirements;
the storage function comprises the steps of maintaining the quality controlled data in a product/service item database for the duration of its useful life, and archiving the data as required to meet regulations;
the maintenance function comprises the steps of when using product/service data stored in the database that has an expired usability date, initiating a data update workflow process to restore the expired product/service data stored in the database to have a non-expired usability date;
the syndication function comprises the steps of selecting product/service data stored in the database, formatting the selected product/service data in at least one required format selected from the group consisting of EXCEL, .csv, .txt, XML, and cXML, and exporting said formatted product/service data to at least one of an external system and a user.
the use function comprises the steps of selecting product/service data stored in the database and obtaining reports thereof formatted according to at least one of a pre-determined report specification and an ad hoc user report specification.

28. A system for Country of Origin compliance, comprising:
data quality control modules to control data quality;
data approval processes to approve quality controlled data for storage in a product/service database;
product/service Country of Origin determination and certification modules for Country of Origin data management, said Country of Origin determination an certification module to determine, certify and store in the database the country of origin of each component of a quality controlled and approved product/service stored in said database;
network communication elements for remote user access to the data quality control modules, data approval processes and data stored in the product/service database;
computer-aided training and certification modules that employ the data quality control and data approval processes to train local users and the network communication elements to train remote users;
syndication modules that syndicate data stored in the product/service database using said network communication elements; and
report generation modules that report data stored in the product/service database.

29. The system of claim 28, wherein the product/service data includes product/service components selected from the group consisting of parts, subassemblies, and processes.

30. The system of claim 29, wherein the product/service components of a product/service are organized into a graphic representation thereof that is stored in the database and associated with the product/service.

31. The system of claim 30, further comprises a plurality of product/service data entry means including:
at least one screen form on a component by component basis, and a graphic “fishbone-like” representation of the product/service components of the product;
a popup form used to select a component of the graphic “fishbone-like” representation and enter data about the component therein; and
at least one user-defined field for each product/service and component thereof that a user designates for a particular purpose and defines the nature of the data that populates the user-defined field.

32. The system of claim 28, wherein the data quality control modules include cleanse, normalize and rationalize product/service data before storage thereof in the product/service database.

33. The system of claim 28, wherein the data approval processes include route selected information via a pre-defined workflow process to obtain ratings from selected approvers.

34. The system of claim 28, wherein the network communication elements include wired and wireless components that enable remote and local users to access the portal and communicate with the product/service database using the data modules and processes.

35. The system of claim 28, wherein the computer-aided training modules include instructional modules to present to a user pre-determined rules and pre-determined requirements related to Country of Origin data management, and to test an ability of the user to make proper discriminations and take appropriate actions that demonstrate the user can act upon the Country of Origin pre-determined rules and pre-determined requirements.

36. The system of claim 35, wherein the certification modules include a test to verify that a user understands and can act upon the rules and requirements of Country of Origin data management.

37. The system of claim 28, wherein the syndication modules include export of data selected from the product/service database in a format for input to another system or use, the format selected from the group consisting of MS Excel, .csv, .txt, XML, and cXML.

38. The system of claim 31, wherein the data entry means is customizable to a plurality of user types selected from the group consisting of manufacturer, importer, supplier, distributor, government contractor, and compliance auditor.

39. The system of claim 28, wherein for an approved product/service stored in the database, the product/service Country of Origin determination and certification modules certify a determined Country of Origin using regulations specified by at least the BAA and TAA trade agreements and the FTC and GSA administration thereof, that the USA has with the determined Country of Origin of a product/service and storing in the database said certification as certification data associated with the approved product/service.
